(19) United States
(12) Patent Application Publication
(10) Pub. No.: US 2017/0175991 A1
(43) Pub. Date: Jun. 22, 2017

(54) LIGHT FIXTURE WITH ADJUSTABLE VENTING SYSTEM

(71) Applicant: GE Lighting Solutions, LLC, East Cleveland, OH (US)

(72) Inventors: Angela WONG, Lachine (CA); Matthew A BUGENSKE, East Cleveland, OH (US); Timothy MILLER, East Cleveland, OH (US)

(21) Appl. No.: 14/974,431

(22) Filed: Dec. 18, 2015

(51) Int. Cl. F21V 29/83; F21V 21/04

(52) U.S. Cl. CPC F21V 29/83; F21V 21/04

(57) ABSTRACT

There is provided a light fixture that includes an air venting system. The light fixture includes a case having at least one reconfigurable surface that alters a flow area of the air venting system.

### TECHNICAL FIELD

The present disclosure generally relates to light fixtures. More particularly, the present disclosure relates to light fixtures that include adjustable venting systems.

### BACKGROUND

When deploying indoor air-vented luminaires, key factors associated with the building in which the luminaires are to be deployed must be taken into account. For example, each building design will require different air flow rate, pressure and noise criteria based on the building's HVAC system, its floor size, and its projected usage. As such, a light fixture that has a fixed air venting system cannot fit each and every building design. This is because all existing light fixtures have air vents that have fixed-size and pre-stamped openings. Consequently, prior to deployment, a typical light fixture must be customized specifically for the building in which it is to be installed. Furthermore, in many cases, an air diffuser with a volume damper is required to regulate airflow. In these cases, both the light fixture and the air diffuser must be customized to fit each other and at the same time meet the building requirements. As a result of the need for customization installing typical indoor air-vented luminaires is costly.

### SUMMARY

The embodiments featured herein help solve or mitigate the above-noted issues as well as other issues known in the art. Specifically, embodiments of the invention provide resizable air vents for indoor recessed light fixtures, thus allowing a light fixture to be compatible with any building design. In other words, the embodiments can be used by customers who require air venting and also by customers who do not require air venting. Moreover, the same fixture can satisfy customers who require high air flows and customers who require relatively smaller air flows. Furthermore, from a manufacturing perspective, the embodiments provide significant cost savings because fewer product skews are needed since one fixture can accommodate a wide range of building designs. Ultimately, the invention provide significant resource savings due to reduced stock handling complexity and fewer or no customer-requested customization.

In one exemplary embodiment there is provided a light fixture that includes an air venting system. The light fixture further includes a case having at least one reconfigurable surface that alters a flow area of the air venting system.

In another exemplary embodiment, there is provided a method that includes altering a flow area in a venting system of a light fixture. The altering can include performing at least one of increasing and decreasing the flow area by configuring at least one surface of the light fixture.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of a light fixture, according to an embodiment.

FIG. 2 is an illustration of a light fixture, according to an embodiment.

FIG. 3 depicts a flow chart of a method, according to an embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

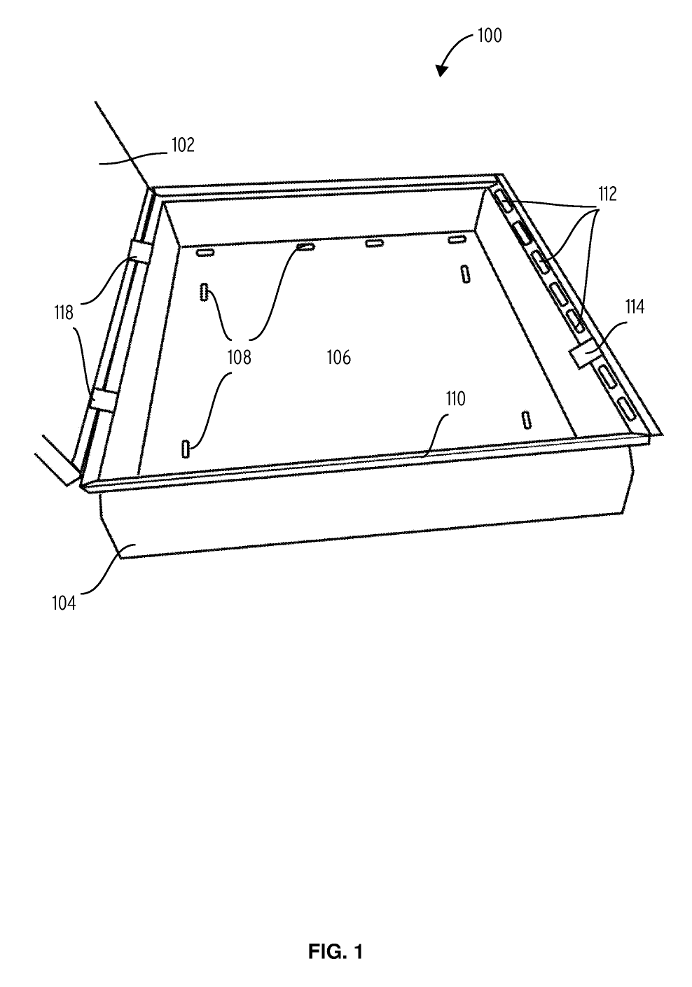

FIG. 1 is an illustration of a light fixture 100, according to an embodiment. Light fixture 100 includes a lid 102, which can include a transparent portion (not shown) to let light through. Light fixture 100 further includes a case 104 into which light sources can be placed on a bottom surface 106. According to various embodiments, these light sources may be light emitting diodes, incandescent lamps, fluorescent lamps, and the like. In general, any type of light source is contemplated without departing from the scope of this disclosure.

Case 104 and lid 102 are linked via hinges 118, of which only two are shown for clarity. Light fixture 100 can have just one hinge or more than two hinges, in alternate embodiments. In yet other embodiments, there may be no hinge at all and lid 102 may simply be secured onto case 104 via plurality of screws, fastening tabs, or any other securing means known in the art.

Case 104 includes an over-hanging edge 110 that extends around its periphery. In one embodiment, edge 110 can include a plurality of openings 112, all around edge 110. In FIG. 1, for clarity and ease of description, only the right-most segment of edge 110 is shown having openings 112. In alternate embodiments, openings 112 can be distributed around edge 110 in an arbitrary fashion. For example, each of the openings 112 can have a size that is different from a nearby opening on edge 110. Alternatively, openings can be distributed on one, two, or three of the segments of edge 110.

Bottom surface 106 also includes a plurality of openings 108. Openings 112 and 108, together contribute to providing an air flow pattern that is capable of cooling light sources and/or electrical components included in case 104. These openings thus form an air-venting system and end connection point between building air-ventilation system to room. As will be described below, in embodiments of the invention, this air-venting system is adjustable.

As noted above, depending on where the fixture is deployed, a specific air flow pattern and pressure may be required. In the exemplary embodiment shown in FIG. 1, any flow requirement can be met, without having a fixture that is specifically designed to meet the desired requirement. Specifically, air flow and pressure may be adjusted, as needed, by either increasing or reducing an effective area into which air may flow.

For example, in FIG. 1, this can be achieved by obstructing one or more openings 112 using a knockout 114, or a plug, or a slab, or a slider, or the like. This allows a user increased flexibility in deploying light fixture 100 as the air flow area can be varied from a maximum area to a minimum area, the maximum area corresponding to all the openings 112 being un-obstructed and the minimum area corresponding to all the openings 108 being obstructed. According to embodiments of the invention, this variation in area can be incremental, the size of the increments determined by the size of the openings 112.

Furthermore, while in the embodiments of FIG. 1, the adjustable portion of the air venting system associated with light fixture 100 is shown to be disposed around edge 110, any part of case 104, including bottom surface 106, can be used to adjust the air flow area. For example, openings in bottom surface 106 can also be obstructed using knockouts, pins, plugs, fold flanges, shutters, or the like, to reduce the air flow area as desired.

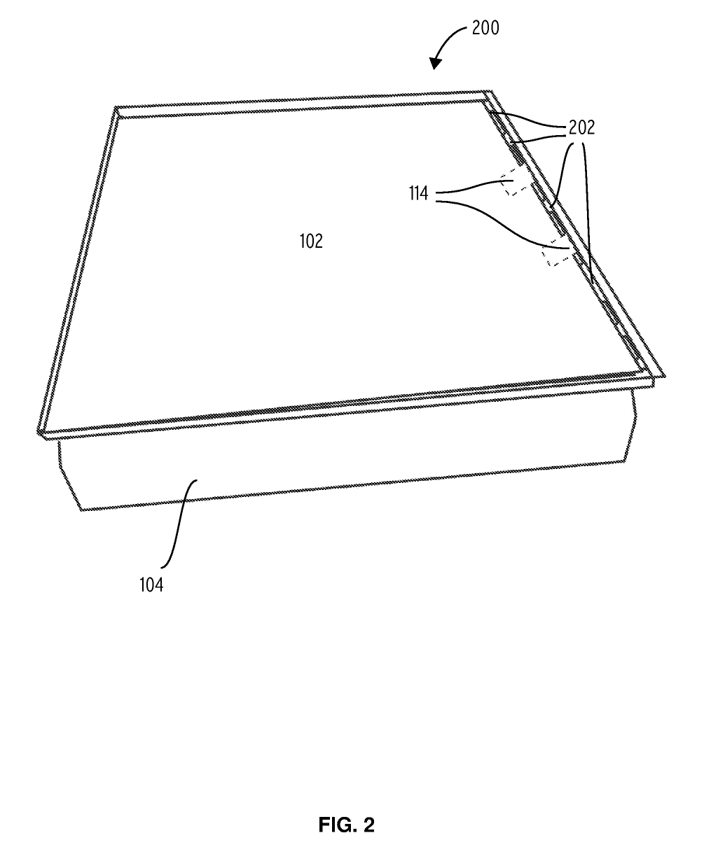

FIG. 2 is an illustration of a light fixture 200, according to an embodiment. Light fixture 200 illustrates lid 102 being closed along with two knockouts 114 being used to obstruct two of openings 202. This arrangement provides a specific air flow pattern and air flow area that may be unique to requirements imposed by a building manager, for example.

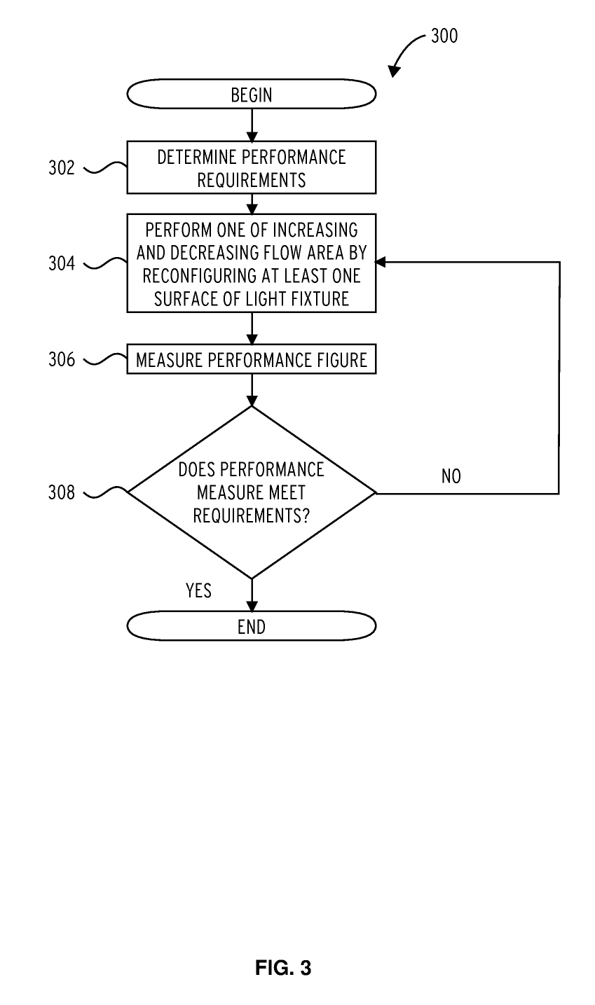

Having set forth the structure of various exemplary embodiments, a method 300 of adjusting a flow area in a light fixture including resizable air vents is now described with respect to FIG. 3. While a specific sequence of steps is shown, one of skill in the art will readily recognize that such sequence is merely exemplary and that one or more individual steps of method 300 may be performed independently.

Method 300 begins at step 302 where a performance requirement is determined based on data associated with a location where a light fixture is to be deployed. For example, the performance requirement may be a specified air flow derived from air flow data, static pressure data, and noise data provided by a building manager.

Based on the determined requirements of step 302, an air venting system of the light fixture, such as the one described in FIG. 1 and FIG. 2, may be adjusted/altered to meet the required performance figure (step 304). This may be achieved by either decreasing or increasing a flow area in a reconfigurable surface of the light fixture, as explained above (i.e. using knockouts or the like to obstruct or un-obstruct openings in at least one reconfigurable surface of the light fixture).

In step 306, the performance figure resulting from the altering performed in step 304 can be measured, for example, with a flow meter. At decision block 308, if the measured performance does not meet the performance requirements, method 300 returns to step 304 where the flow area is either decreased or increased in an attempt to meet the required performance. Method 300 ends only when the measured performance meets the required performance.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A light fixture comprising:
an air venting system; and
a case having at least one reconfigurable surface that alters a flow area of the air venting system.

2. The light fixture of claim 1, wherein the at least one reconfigurable surface includes a plurality of openings.

3. The light fixture of claim 2, wherein at least one opening is fitted with movable knockout.

4. The light fixture of claim 3, wherein the movable knockout can be moved such that the at least one opening is either obstructed or unobstructed.

5. The light fixture of claim 2, wherein the at least one opening is fitted with one of a plug, a pin, a tab, a fold flange, a sliding mechanism, and a knockout.

6. The light fixture of claim 1, wherein the at least one reconfigurable surface is on an edge overhanging the case.

7. The light fixture of claim 1, comprising four continuous reconfigurable surfaces that form an overhanging edge around the case.

8. The light fixture of claim 1, further comprising a lid.

9. The light fixture of claim 1, wherein the light fixture is a recessed light fixture.

10. The light fixture of claim 1, wherein the at least one reconfigurable surface includes at least one fold flange.

11. A method, comprising:
altering a flow area in a venting system of a light fixture, the altering including:
performing one of increasing and decreasing the flow area by reconfiguring at least one surface of the light fixture.

12. The method of claim 11, wherein reconfiguring the at least one surface includes one of obstructing and un-obstructing at least one opening in the at least one surface.

13. The method of claim 11, wherein reconfiguring the at least one surface includes changing a position of at least one movable knockout.

14. The method of claim 11, wherein performing one of increasing and decreasing the flow area is achieved incrementally.

15. The method of claim 11, wherein an increment used in the altering is given by a size of an opening in the at least one surface.

16. The method of claim 11, comprising determining a required air flow based on data associated with an area in which the light fixture will be deployed.

17. The method of claim 15, further comprising altering the flow area to meet the required air flow.

18. The method of claim 15, wherein the data includes air flow data, static pressure data, and noise data.

19. The method of claim 10, further comprising determining a performance figure following the altering.

20. The method of claim 19, wherein the performance figure is based on a number of openings of the at least one surface that are unobstructed.
